(19) United States
(12) Patent Application Publication
(10) Pub. No.: US 2014/0344469 A1
(43) Pub. Date: Nov. 20, 2014

(54) METHOD OF IN-APPLICATION ENCODING FOR DECREASED LATENCY APPLICATION STREAMING

(71) Applicant: Evology, LLC, Sarasota, FL (US)

(72) Inventor: Jason Frederick Nicholls, Pretoria (ZA)

(73) Assignee: EVOLOGY, LLC, Sarasota, FL (US)

(21) Appl. No.: 14/280,426

(22) Filed: May 16, 2014

Related U.S. Application Data
(60) Provisional application No. 61/824,655, filed on May 17, 2013.

(51) Int. Cl. H04L 29/06

(52) U.S. Cl. CPC H04L 65/607
USPC 709/231

(57) ABSTRACT

A method of in-application encoding for decreased latency application streaming in an environment (e.g. MS Windows) including a three-dimensional image or video generating application. An API includes providing a customized sub-program (e.g., a DLL file) in the application. The sub-program includes an encoder operable to encode an image. Further, the method includes creating a protected memory block sufficient to accommodate the largest possible image that the application could generate. In addition, the method can include copying data from a back buffer of the API to the memory block and indicating that data in the memory block is ready for encoding. By using the sub-program of the application, the method can include encoding the data in the memory block for onward streaming (e.g., to a client terminal) of the encoded data.

### RELATED APPLICATION

This application claims the benefit of priority of U.S. Provisional Application Ser. No. 61/824,655, entitled “A Method of In-Application Encoding for Decreased Latency Application Streaming,” filed May 17, 2013, the content of which is hereby incorporated by reference in its entirety.

### TECHNICAL FIELD

This disclosure relates to a method of, and system for, in-application encoding for decreased latency application streaming across a telecommunications network to a client terminal.

### BACKGROUND OF DISCLOSURE

The Applicant is aware of existing computer-implemented methods and systems which facilitate server-based hosting and execution of software applications which provide a video output and streaming of the video output to a remote client terminal. These methods and systems find particular application in online gaming, in which case the software application is a computer game.

In a particular method, a user installs a streaming client on his client terminal which can then access a central server, which redirects the client to an available game server. The user is then presented with a list of possible games (or other applications). The user then selects a game from the list, which in turn triggers the server to start the game. Once the game is running on the server, a video stream is started and game images are streamed via a telecommunications network to the client. All user interactions with the client are captured and sent to the server, where the commands are injected into the running game. This creates the illusion of local game play. From the user's perspective the game could just as well be running locally (i.e. on the client terminal).

Realism depends on the quality of the streamed video as well as the time it takes for the video to be generated and streamed to the client. It is difficult for a user to detect delays in static (i.e. pre-defined, non-interactive) video streams (e.g. a movie) as he has no point of reference, unless a source and target video were played simultaneously and next to one another, such that the user could view the source and the target at the same time.

However, delays in an interactive video can very easily be detected, as the user input may take a while to be represented in the video. This is exacerbated in gameplay, especially for fast-paced games, where near instant reaction times are needed. At worst, delays render a game unplayable, at best, merely annoying.

Video quality is dependent on a number of factors. To understand this, a deeper understanding is required of the game streaming process, from capture to render. An understanding of this process will also explain the latency. Latency is a technical term to describe the time it takes for a block of data to move along a data track, from source to destination. In game streaming, latency can be the time it takes for the rendered video to be captured and streamed to the client terminal, and rendered again locally for viewing by the user.

The streaming client requests a game from the server. The server then starts the game on the server. Generally the game will perform some kind of three-dimensional modeling, and at a given point in time the game will request of the modeling engine an image or a render. A simplified analogy of this process is that of a person observing people moving through a camera lens. The people are moving within a three-dimensional world. At a defined time, when the observer decides, the observer clicks the camera's capture button. At that point, a snapshot is taken and a two-dimensional image is produced. If multiple two-dimensional images are produced in quick succession, and flashed back on a screen at the same capture rate, an illusion of a video of the three-dimensional world is produced.

The computer gaming environment works similarly. A three-dimensional world is produced and snapshots of the world are taken. These snapshots are moved to temporary storage known as a back buffer. The back buffer is then flipped onto the screen for only a few milliseconds. At the same time, another image is captured onto the back buffer. After the original image is displayed it is discarded, and the subsequent image flipped onto the screen.

Input commands and game logic alter the three-dimensional world, thus creating the illusion of interactivity. If a copy of the back buffer is made before it is flipped to the screen, it could be encoded and transmitted as a video stream, to be rendered on a different screen. PCT/IB2013/052172 (incorporated herein by reference) describes a method for capturing a rendered image from the back buffer.

Computer games may be programmed in many different ways; however, they all make use of common three-dimensional engines. A limited number of engines exist, namely DirectX, Open GL and GDI. Further, a program is made up of a number of sub-programs or sub-routines. These sub-programs all reside inside memory. When a sub-program is called, a memory reference to the sub-program is obtained. This memory address is passed to the processor for processing. The processor accesses the memory address and executes the commands that reside in the sub-program at the memory address.

In order to intercept a call to the memory address containing the sub program, knowledge of where the location of the address reference is stored is needed. It is possible to change the address reference to point elsewhere, e.g., to an alternate sub-program or DLL. The processor will be given the changed address reference to execute and not the original sub-program address. This process is known as hooking or patching. In order to patch a game, a Dynamic Linked Library (DLL) is loaded within the game's memory space, memory is altered, and the game continues to run.

It would be easier to access the three-dimensional game engine API, as opposed to the actual program logic of the application or computer game, because there are fewer API variants. PCT/IB2013/052172 exploits this by intercepting calls/memory addresses to the API.

Thus, one way to extract the image from the back buffer is to use a remote procedure call or RPC. The back buffer image is extracted and converted into a Bitmap image (or other raster image format). This bitmap is made serializable (i.e. converted into a binary, serial stream of data) and sent via an IO stream over the RPC to the server. The server creates a new bitmap from the data and passes it to a video encoder. This encoder scales the image, manipulates it and finally encodes it as a video stream to be sent to the client terminal.

The Applicant thus desires a method for decreased latency application streaming which can create an encoded, streamable image more quickly.

### SUMMARY OF DISCLOSURE

According to one aspect of the disclosure, there is provided a method of in-application encoding for decreased latency application streaming in an environment including a three-dimensional image or video generating application and an API, the method including:
providing a customized sub-program in the application, the sub-program including an encoder operable to encode an image;
creating a memory block sufficient to accommodate the largest possible image that the application could generate, the memory block being protected;
copying data from a back buffer of the API to the memory block;
indicating that data in the memory block is ready for encoding; and
encoding, by the sub-program of the application, the data in the memory block for onward streaming of the encoded data.

In other words, in perhaps over-simplistic terms, the encoding function has been relocated from outside the application (e.g. from the gaming server software or streaming agent software) to within the application, to reduce the number of data transfer steps and accordingly the latency.

The method may include communicating the address of the memory block to the encoder. Data may be copied directly from the back buffer to the memory block for encoding.

Protecting the memory block may not necessarily mean locking it or write-protecting it. The method may include declaring or demarcating the memory block as unsafe. Unsafe memory is memory that is managed by an application and not the garbage collector, in a managed application. This prevents inadvertent deletion of the data in the memory block.

The application may be operable on a Microsoft™ Windows™ platform. The sub-program may be in the form of a Dynamic Linked Library (DLL).

The method may utilize a semaphore to regulate protection of the memory block. The semaphore may be a counting semaphore or a binary semaphore. An increase in the semaphore may indicate a memory lock. A memory lock may indicate that new data is in the memory block and is ready for encoding. Once the data has been encoded, the semaphore may be decreased. A decrease in the semaphore may indicate that the memory block is available to receive new data from the back buffer. A decrease in the semaphore may trigger copying of the data in the back buffer to the memory block.

The sub-program may employ existing encoding algorithms, such as Motion Picture Expert Group (MPEG4) for the container and Advanced Video Encoding (AVC) such as H264 for the encoding. Alternatively, Audio Video Interleave (AVI) may be the container and the image may be RIFF (Resource Interchange Format File), MOV. Other encoding schemes may include H120, H261, H263, VC2. Images may be encoded into video using the compression (encoding scheme), and video may then be merged with audio (e.g. using MP3, PCW, WAV, PCM, ULaw, Celt, etc.) and placed in a container, e.g. MOV, AVI, MP4, etc. to produce a video stream. The stream may then be encoded into a file, or network stream.

Providing the customized sub-program may include patching the application to introduce the sub-program including the encoder. The patching may include adding (or replacing) at least one DLL file to an existing DDL system of the application. The patching may be done prior to execution of the application. The patching may include changing a memory reference in the application to point to the new sub-program.

According to another aspect of the disclosure, there is provided a system for in-application encoding for decreased latency application streaming in an environment including a three-dimensional image or video generating application and an API, the system including:
an application server operable to stream application images/video to a remote client terminal;
an application operable to render images based on a modeled three-dimensional environment;
an image encoder operable to encode an image; and
a control module operable to:
   create a memory block sufficient to accommodate the largest possible image that the application could generate, the memory block being protected;
   communicate an address of the memory block to the encoder;
   copy data from a back buffer of the API to the memory block; and
   indicate that data in the memory block is ready for encoding,
the encoder being operable to encode the data in the memory block for onward streaming of the encoded data.

Once the image has been encoded, it is ready for streaming and may be streamed in various ways. The precise streaming mechanism is not germane to this disclosure but, for example, may use streaming mechanisms disclosed in PCT/1B2013/052172 or possibly even methods/systems of other proprietors such as those disclosed in U.S. Pat. No. 8,147,339 or U.S. Pat. No. 8,203,568. Differently stated, the present disclosure involves the generation and encoding of images intended to be streamed, rather than the streaming itself.

To appreciate how the decrease in latency is realized, it is important to understand out-of-application encoding and streaming. In prior disclosures, data from the back buffer of the API is captured, e.g. by the streaming agent or server software (i.e. out-of-application), and converted to a bitmap image and sent via an IO stream to the server/agent via an RPC. The server/agent creates a new bitmap from the IO stream and parses it to an encoder.

A bitmap can be very large. Given a resolution of 640×480 pixels, where each pixel is represented by 3 primary colors and an invisibility gradient known as an alpha value, and given that each color and alpha value is 8 bits or 1 byte in size, this would result in 1,228,800 bytes of memory. This must then be serialized, sent over a stream, marshaled back into an object, manipulated and encoded. A standard image is generally in excess of 1024×768 and uses 2 bytes to encode each color component and 2 bytes to encode each alpha component (i.e. 8 bytes to encode the color and alpha). This image would be 6,291,456 bytes in size.

In prior disclosures, high speed transfer is achieved by scaling the intercepted image. This results in a smaller serialized stream, meaning less to copy and faster to transfer. However, a smaller image results in decreased quality. Thus, the prior process comprises: copying data from the back buffer, serializing it, streaming it over RPC to the game agent/server, turning it into a bitmap, parsing it to the video encoder, scaling and encoding it.

The present disclosure obviates most of these steps, resulting in:
decreased size of the data required to transfer and process;
increased processor and memory processing speed;
removed steps within the process; and
shared memory space to avoid copying data,
   which results in lower latency.

The disclosure extends further to a non-transitory computer-readable medium having stored thereon a computer program which, when executed by a computer, causes the computer to perform a method as defined above.

### BRIEF DESCRIPTION OF DRAWINGS

The disclosure will now be further described, by way of example, with reference to the accompanying diagrammatic drawings.

In the drawings:

FIG. 1 shows a schematic view of a system for in-application encoding for decreased latency application streaming, in accordance with the disclosure;

FIG. 2 shows a schematic view of an application server forming part of the system of FIG. 1;

FIG. 3 shows a flow diagram of a method for patching an application prior to execution of the application;

FIG. 4 shows a method of in-application encoding for decreased latency application streaming, in accordance with the disclosure; and

FIG. 5 shows a diagrammatic representation of a computer within which a set of instructions, for causing the computer to perform any one or more of the methodologies described herein, may be executed.

### DETAILED DESCRIPTION OF EXAMPLE EMBODIMENT

The following description of the disclosure is provided as an enabling teaching of the disclosure. Those skilled in the relevant art will recognize that many changes can be made to the embodiment described, while still attaining the beneficial results of the present disclosure. It will also be apparent that some of the desired benefits of the present disclosure can be attained by selecting some of the features of the present disclosure without utilizing other features. Accordingly, those skilled in the art will recognize that many modifications and adaptations to the present disclosure are possible and can even be desirable in certain circumstances, and are a part of the present disclosure. Thus, the following description is provided as illustrative of the principles of the present disclosure and not a limitation thereof.

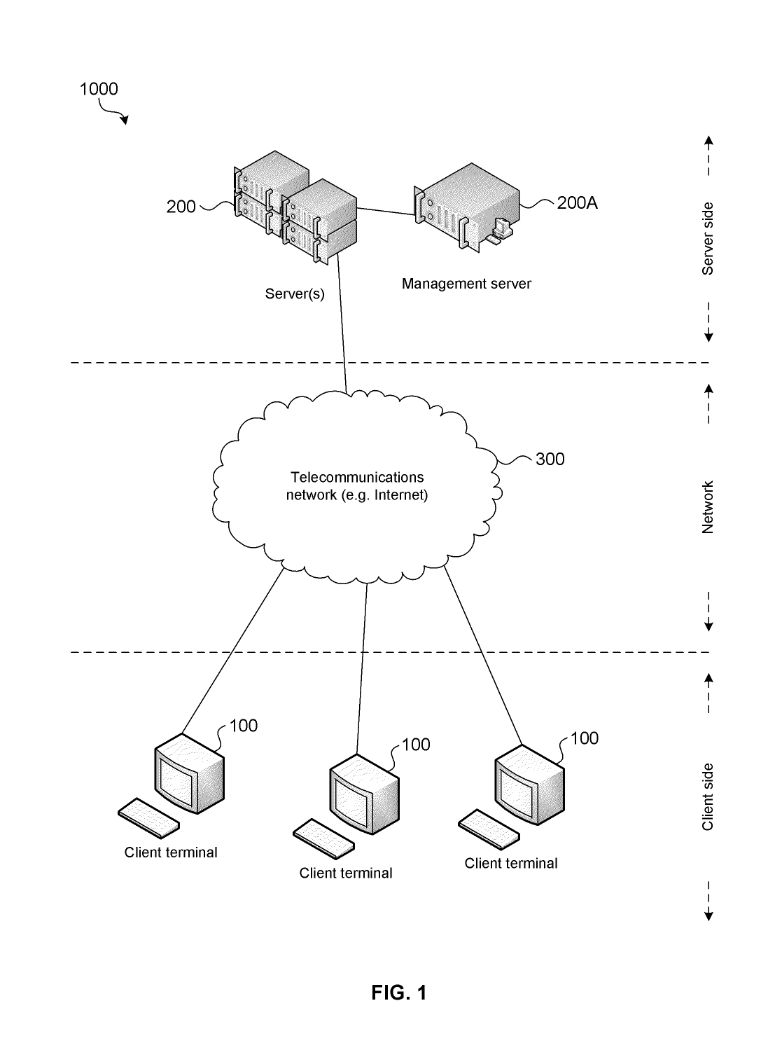

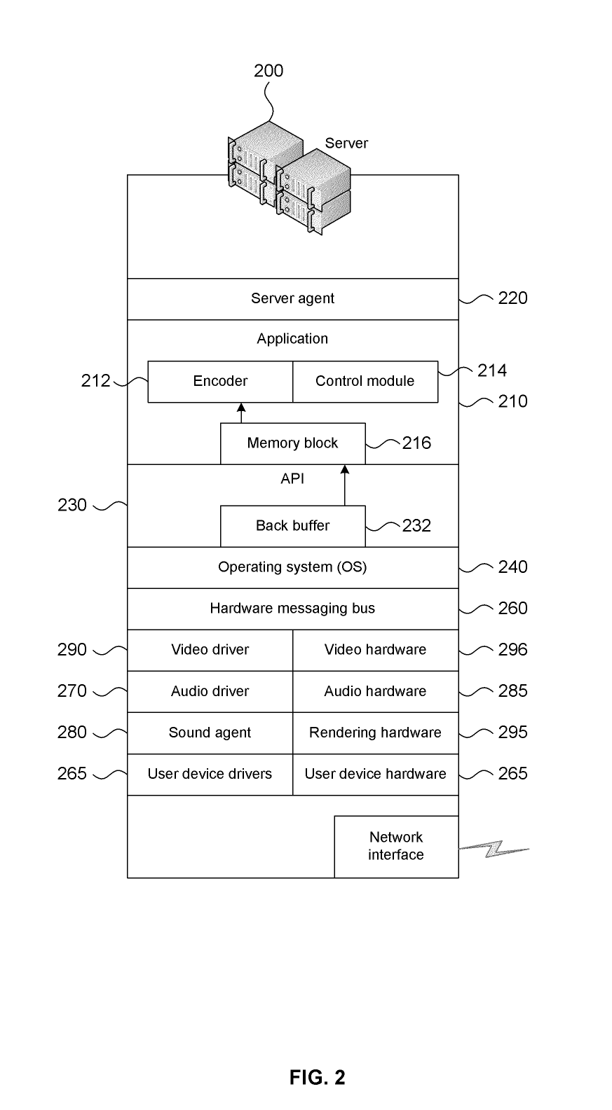

FIG. 1 is an example of a system 1000 for displaying graphically rendered video images, and optionally for outputting audio, on a network-coupled client terminal 100. The video and audio are generated on a server 200 by a software application 210 (FIG. 2) that is designed to run in an integrated hardware environment with physically coupled user input devices, and display components and audio components. Example software applications include computer games, computer design/drawing packages, and flight simulators. An example of such integrated hardware environment is the server 200 but can include PCs (personal computers), laptops, workstations, tablets, mobile phones, and gaming systems.

The software application 210 is designed to have an execution environment where the video and audio is generated by system calls to standard multimedia APIs (Application Programming Interfaces) 230. The video and audio are output on devices and sound cards physically attached to the computer. Further, the executing applications 210 (FIG. 2) utilize operating system features for receiving user inputs from physically attached keyboards and pointing devices such as a mouse or trackball or touchscreen.

The system 1000 is configured for sending rendered graphic images or video frames through a network 300 to the client terminal 100 in a format compatible with a client agent installed on the client terminal 100. Additionally, the audio is formatted to be compatible with the client agent. The system 1000 is also configured for user inputs to be generated by the client terminal 100 and to be injected into an operating system 240 of the server 200 in a manner in which the application 210 sees these inputs as coming from hardware directly attached to the server 200.

There are a number of advantages of this architecture over integrated standalone systems. For best application performance, a standalone system require high performance CPU's, multicore graphic processors, and large amounts of memory. The resulting trade-off is that a standalone system is power hungry, costly, difficult to share economically between multiple users, is typically larger and heavier, all of which limit mobility. By dividing the processing between a sharable high performance application and graphics processing server 200, and sending the rendered graphic images and audio to the client terminal 100, a beneficial system balance is achieved. Further, the server 200 can serve a plurality of client terminals 100 (FIG. 1).

Graphic intensive software applications can run on high performance server hardware while the resulting graphic images are displayed on a wider variety of client terminals 100 including but not limited to mobile phones, tablets, PCs, set-top boxes, and in-flight entertainment systems. The expensive hardware components can be shared without reducing mobility. Applications that have not been ported to a mobile device or would not be able to run on a mobile device due to memory or processing requirements can now be utilized by these client devices with only a port of client components. Further, new models of renting applications or digital rights management can be implemented.

The server 200 comprises high-performance hardware and software needed to provide real-time graphics rendering for graphics intensive applications. The server 200 is configured for executing application software 210 in a system environment that appears as if it is executing in a hardware environment with an integrated display 296 and audio hardware 285 to which the generated video and audio are output. This hardware is not actually required to be present but optionally is present.

The server 200 captures or copies the rendered graphic images and encodes new graphic images compatible with the client terminal 100 and the communication bandwidth between the server 200 and client terminal 100. This processing can include resizing and compressing the images and configuring the data into a format required by the client terminal 100. The execution environment may be indicated to the application 210 to be a physical display 296 resolution different than that of the client terminal 100. Also, the client terminal 100 can have different audio capabilities from what is generated by the application software 210. The application software 210 may generate multiple channels of sound intended for a multi-speaker configuration whereas the client terminal 100 may have only one or two channels of audio outputs.

Thus, the server 200 buffers the video and audio data, resizes the video and audio data to be compatible with the client terminal 100, and compresses the data to match the available bandwidth between the server 200 and client terminal 100.

The server 200 can be part of a server farm containing multiple servers. These servers 200 can include a management server 200A for system management. The servers 200 can be configured as a shared resource for a plurality of client devices 100. Further, the servers 200 may include a plurality of physical and/or virtual servers. It is an advantage of the present disclosure that virtualization is possible due to the software-based implementation.

The elements of the server 200 are configured for providing a standardized and expected execution environment for the application 210. For example, the standardized application 210 might be configured for running on a PC (personal computer) that has a known graphic and audio API 230 for generating graphic frames and audio for local output. The application 210 can be configured for using this API 230 and to receive input from a remote input device 150 associated with the client terminal 100. The server 200 is configured for mimicking this environment and to send the rendered graphics images and audio to the network coupled client terminal 100. User inputs are generated and transmitted from the client terminal 100 as opposed, or in addition, to a physically coupled user device 267.

The network 300 comprises any global or private packet network or telecommunications network including but not limited to the Internet and cellular and telephone networks, and access equipment including but not limited to wireless routers. Preferably the global network 300 is the Internet and cellular network running standard protocols including but not limited to TCP, UDP, and IP. The cellular network can include cellular 3G and 4G networks, satellite networks, cable networks, associated optical fiber networks and protocols, or any combination of these networks and protocols required to transport the process video and audio data.

The client terminal 100 is coupled to the network 300 either by a wired connection or a wireless connection. Preferably the connection is broadband and has sufficient bandwidth to support real-time video and audio without requiring compression to a degree that excessively degrades the image and audio quality.

The client terminal 100 may use standard Internet protocols for communication between the client terminal 100 and the server 200. Preferably, three ports are used in the connection between the client terminal 100 and server 200. Preferably the video and audio is sent using UDP tunneling through TCP/IP or alternatively by HTTP but other protocols are contemplated. Also, the protocol may be RTSP (Real Time Streaming protocol) provided by Live555 (Open Source) used in transporting the video and audio data.

A second port is used for control commands. Preferably the protocol is UDP and a proprietary format similar to Windows message is used but other protocols are contemplated. A third port is used for system commands. Preferably these commands are sent using a protocol that guarantees delivery. These protocols include TCP/IP but other protocols are contemplated. This may be required for game interaction rather than streaming.

Referring to FIG. 2, an example configuration of the server 200 is illustrated in one embodiment of the disclosure. In this embodiment, an application 210 (e.g. a computer game) is configured for generating graphic video frames through software calls to an API 230 such as DirectX or Open GL.

In a conventional configuration (excluding new elements in accordance with the disclosure), the programming API 230 communicates with the operating system 240 that in turn communicates with the graphics drivers 290 and video hardware 295 for generating the rendered graphic frames, displaying the rendered graphics 296, and outputting application-generated audio to the audio hardware 285. (It should be noted that the terms “image”, “graphic”, “frame” and “video” may be synonymous or overlapping and should be interpreted accordingly.)

However in the embodiment shown in FIG. 2, the server 200, and more specifically, the application 210, is configured for capturing the rendered video images, and encoding the video data to be compatible with the client terminal 100, and sending the processed video frames (and optionally audio) over the network 300 to the client terminal 100 for display and audio playback. Further, the server 200 in FIG. 2 is configured for receiving user inputs from the client and inserting them into the operating system environment such that they appear to be coming from physically connected user hardware.

The server 200 is configured with an application 210. The application 210 can include any application 210 that generates a video output on the display hardware 296 (which may include a graphics processor). The applications 210 can include computer games but other applications are contemplated. The application 210 can upon starting load and install a multimedia API 230 onto the server 200. This API 230 can include DirectX 9, DirectX 10, DirectX 11, or Open GL but other standards based on multimedia APIs are contemplated.

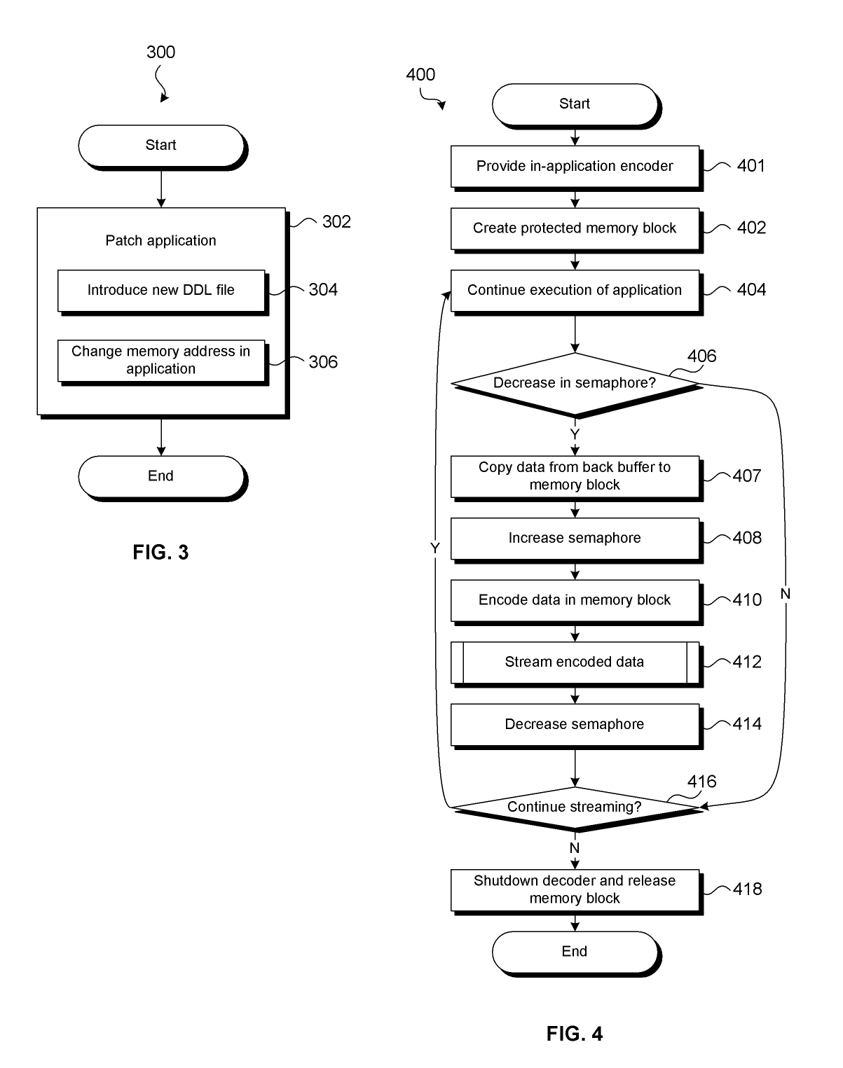

Prior to initializing the application 210 for the first time, it is adapted or patched (FIG. 3) to install a customized sub-program. The sub-program may be in the form of a DLL file which is patched into the application's library of DLL files. The sub-program provides an encoder 212 as well as a control module 214 to manage the data flow process. It will be noted that, after patching, the encoder 212 and the control module 214 reside in the application 210. The server 200 thus provides in-application encoding.

The server 200 may include a processor (not illustrated) and the control module 214 may be a conceptual module corresponding to a functional task performed by the processor. To this end, the server 200 may include a computer-readable medium, e.g. main memory, and/or a hard disk drive, which carries a set of instructions to direct the operation of the processor, the set of instructions for example being in the form of a computer program. It is to be understood that the processor may be one or more microprocessors, controllers, digital signal processors (DSPs), or any other suitable computing device, resource, hardware, software, or embedded logic.

The control module 214 is operable (among other things) to create or establish (FIG. 4) a memory block 216 sufficient to accommodate the largest possible image that the application 210 could generate. The memory block 216 is part of application-controlled memory. The control module 214 also protects the memory block 216 by use of a semaphore to control the availability of the memory block 216. The control module 214 is also operable to copy data, e.g., in the form of a rendered image, from a back buffer 232 of the API 230 to the memory block 216. The encoder 212 may then encode the data in the memory block 216 in accordance with an encoding algorithm and encoding criteria for streaming to the client terminal 100.

A server agent 220 may communicate the encoded image via the telecommunications network 300 using a network interface to the client terminal 100. The server agent 220 also receives user inputs from the client terminal 100 and inputs them into the operating system 240 or hardware messaging bus 260 in a manner to appear as if they were received from the physically attached hardware 267. Physically connected hardware 267 typically injects messages into what is referred to as a hardware messaging bus 260 on Microsoft Windows operating systems. As user inputs are received from the client terminal 100 the server agent 220 converts the commands into a Windows message so that the server 200 is unaware of the source. Any user input can be injected into the Windows message bus 260. For some applications, a conversion routine converts the Windows message into an emulated hardware message. However, other operating system and methods for inputting messages and other operating system method for handling user inputs by the operating system 240 are contemplated.

The multimedia API 230 provides a standard interface for applications to generate video frames using the server hardware 295. Preferably the multimedia API is DirectX and its versions, Open GL, or GDI. However, the disclosure contemplates new and other API interfaces. The API 230 can be loaded by the application 210 or can be preinstalled on the server 200.

The server 200 is configured for an operating system 240. The operating system 240 can be any standard operating system used on servers or PC's. Preferably the operating system 240 is one of Microsoft's operating systems including but not limited to Windows XP, Server, Vista, Windows 7, or Windows 8. However, other operating systems are contemplated. The only limitation is that the application 210 needs to be compatible with the operating system 240.

The encoder 212 is configured for formatting each frame to be compatible with a display of the client terminal 100, compressing each video frame, and sending the resized and compressed frame to the client terminal 100. Because the application 210 can generate graphics frames targeted to a video device 296 coupled to the server 200, the generated graphics may be different from the size, dimensions, and resolution of the client terminal 100. For example, the application 210 could be generating graphic video frames for a display having a resolution of 1680×1050. The client terminal 100 could have a different display resolution, 1080×720 for example. For the server rendered frame to be displayed on the client terminal 100, the frame needs to be resized.

Further, to save transmission bandwidth and to match the available transmission bandwidth between the client 100 and server 200, the rendered frame may be compressed. The encoder 212 may also be responsible for compression. A lossless or lossy compression can be used. If the bandwidth is insufficient for a lossless transmission of data, then the compression may have to be lossy. Preferably, the compression and reformatting standard ITU-T H.264 codec is used. Preferably, there is buffering of only one frame of video. If the processed frame is not transmitted before the next frame is received, then the processed frame is discarded. This ensures that only the most recent frame is transmitted to increase the real-time response and decrease latency. The encoding and compression may be simultaneous.

The server 200 is configured with video drivers 290 and rendering hardware 295 for generating and displaying video frames on the server. The video driver 290 is a standard driver for the frame rendering hardware 295. The server 200 can have display hardware 296 attached to it. The server agent 220 can process audio. The audio or a copy of the audio is buffered. Preferably, the size of the audio buffer is the same as the frame rate so that the audio and frames can be in sync. The buffered audio, if needed, is modified to match the audio capability of the client terminal 100 and the audio is compressed, preferably with a low delay algorithm. Preferably, a CELT codec or other low latency codec is used for compression.

### Operational Example

An operational example will now be described with reference to FIG. 3 and FIG. 4. FIG. 3 illustrates a simple method 300 of adapting the application 210 prior to execution thereof. The application 210 is patched (at block 302) by adding a (at block 304) custom sub-program, in the form of a DLL file, to the application 210. Code in the application 210 is modified (at block 306) to call or reference the custom DLL file at appropriate times. The DLL file includes the encoder 212 and the control module 214.

A specific patch may need to be developed for each application. In other words, a patch for one application may well not work on another application. However, once the application 210 has been patched, it does not need to be re-patched each time it is launched—an initial patch is sufficient.

It will be appreciated that the method 300 only needs to be implemented for conventional applications which do not natively include the decoder 212. It is envisaged that future applications could be developed/programmed to include a native in-application encoder 212, in which case no patching would be necessary.

FIG. 4 illustrates a more detailed flow-diagram of a method 400 in accordance with an example embodiment. Although the methods 300-400 of FIGS. 3-4 are described with reference to the system 1000, it will be appreciated by one skilled in the art that the methods 300-400 may be implemented on a different system and similarly that system 1000 (and server 200 and client terminal 100) may be configured to implement different methods.

Initially, a connection between the client terminal 100 and the server 200 is initiated. The connection is setup by both the client terminal 100 and the rendering server 200 connecting to a URL (uniform resource locator) management server 200A over the Internet 300. The URL management server 200A receives a public IP and port address from each rendering server 200 that connects to it. The IP and port address from this server 200 and other servers 200 are managed as a pooled resource. An IP and port address for an available rendering server 200 is passed to the client terminal 100.

The rendering server 200 can have multiple applications 210 configured within it. A menu of applications 210 can be sent to the client terminal 100 for user selection. Upon user selection, a message is sent to the server 200 to start the application 210, which in this example is a graphics-intensive computer game. The application 210 then begins execution on the rendering server 200. The rendering server 200 may advantageously be configured for applications 210 that require physically connected hardware display devices and user input devices to execute. Thus, the application 210 (e.g. a computer game 210) may have been intended for a stand-alone (e.g. non-networked) environment.

The application 210 provides (at block 401) an in-application encoder, either as a result of the previous patching (at block 302) of the application 210 or as a result of development of the application 210 for use in accordance with the method 400.

Upon initializing the game 210, the control module 214 creates (at block 402) a memory block 216 which is sufficiently large to accommodate data for the largest image which the game 210 could produce, even if current game settings are at a lower resolution. The memory block 216 is classified as application-specific memory but it is protected. An example of a protection/availability mechanism is a semaphore to indicate when the memory block may be written to, and when not. Thus, it is the control module 214 which controls the semaphore and hence access to the memory block 216, to prevent inadvertent use by the game 210. The control module 214 decreases the semaphore to indicate that the memory block 216 is available or may be overwritten.

The game 210 continues execution (at block 404) as it would normally, e.g. by generating a three-dimensional model or world and interacting with the API 230 in a conventional manner to produce two-dimensional renderings of the model. The API 230 temporarily stores the data of the image rendering in its back buffer 232. Usually, the data in the back buffer 232 would be flipped to the video hardware 296 for display.

However, in accordance with the present embodiment, the control module 214 monitors (at block 406) when the semaphore is decreased to indicate that the memory block 216 is available. When it is available, the image data in the back buffer 232 is copied (at block 407) to the memory block 216. To ensure that the game 210 does not inadvertently overwrite the memory block 216 before encoding, the semaphore is increased (at block 408) to indicate a memory lock.

The image data in the memory block 216 is then encoded (at block 410) by the in-application encoder 212. The encoder 212 may vary the encoding characteristics based on, e.g., configuration of the client terminal 100, bandwidth available in the network 300, user preferences, etc.

If the driver 290/hardware 296 for which the API 230 believes it is rendering the image matches local video hardware 120 of the client terminal 100, then the rendered image may not need to be reformatted. However, this may involve configuring the server driver 290/hardware 296 to mirror the settings of the client terminal 100. Instead, the encoder 212 may have configuration details of the client terminal 100 and be operable to re-format, e.g. re-size, the rendered image to match the capabilities of the client terminal 100. It would be bandwidth-inefficient to transmit a 1080p image if the client terminal 100 can display at most a 480p image. More specifically, after copying the rendered graphics image from the back buffer 232, the image needs to be processed to account for any difference between the screen resolution of the client terminal 100 and the resolution at which the application 210 is operating. This processing can include down-sampling, up-sampling and pixel interpellation or any other resolution scaling methods. Some video codecs both compress and resize to new screen resolutions. One video compression codec that provides these functions is H.264.

The encoded image is then streamed (at block 412) via a network interface of the server 200. If desired, the image may be manipulated (watermark, advertising, messages, scaling, color correction, etc.) by the encoder 212.

Although not specifically illustrated, in addition to images/video, audio may also be streamed. Where the application 210 is configured for generating audio utilizing a multimedia API 230 and outputting the audio through a physically attached audio card, the audio is also intercepted, read from the back buffer 232, and transcoded into a format decodable by the client terminal 100. The processed audio is compressed, and transmitted to the client device. Thus, audio generated for five channel surround sound can be output on a client device having only one or two audio channels. References to graphic image in the method 400 could be substituted with references to audio (with the necessary modifications) or to multimedia (video and audio).

Additionally, the application 210 can require a multi-channel audio capability. A stream of multiple channels of digital sound can be generated through calls to a standardized multimedia API. These API's can include DirectX 9, 10, Open GL, or GDI. Again, the APIs are configured on either loading or on the server startup to redirect or make a copy of the audio data from the back buffer for processing and transmitting to the client terminal 100. Like the rendered graphic images, the audio is compressed to conserve bandwidth.

Any audio compression algorithm can be used but low delay transforms are preferred. Preferably, CELT (Constrained Energy Lapsed Transform) audio codec is used due to its low delay, but another low latency codec could be used.

To make sure that the audio and video frames are in sequence and synchronized, the audio data is tied or mixed with the video frame data. If a video frame is over written due to delays, so is the audio data. In such case, the method 400 may include the additional step of associating/synchronizing a rendered image with a portion of audio. If changes in the available transmission rate cause an image not to be transmitted, then the image is overwritten with the latest image and the processed image and processed audio are replaced by the latest image and audio. By doing so, the real-time responsiveness of the client terminal 100 is maintained as much as possible. The server 200 can increase or decrease compression as the transmission bandwidth between the server 200 and client terminal 100 changes.

The client terminal 100 receives and decodes the rendered image.

Once the encoded image has been transmitted, the data in the memory block 216 is no longer needed. The control module 214 decreases (at block 414) the semaphore to indicate that the memory block 216 is available. If streaming continues (at block 416), the method 400 may repeat from block 404.

Alternatively, if streaming is to be concluded for any reason, the decoder 212 is shut down and the memory block 216 is released (at block 418). Careful controls may need to be implemented to ensure that shut down is complete. If this is not done, the memory block 216 (or other memory) could be corrupted and a “memory leak” can occur. A memory leak is when memory is no longer used by a program, and it is still in a dirty state. A dirty state means that it is indicated as being used by something when in actual fact it is not being used by anything. Memory leaks slowly eat away at the available memory until eventually no more memory can be allocated to a process and a computer “crashes”.

Further considerations when implementing the method 400 are that:
Injecting a large DLL file that includes video encoding could result in the DLL file exceeding available memory bounds, which could crash the host application. Thus, the DLL file and encoder 212 should be sized appropriately.
The host application 210 could prematurely shut down the video streaming resulting in a memory leak, host application crashing, or corrupt data being streamed.
A premature shut down could result in the client terminal 100 not knowing of the termination, and continuing to receive a video stream. As no video is available, the client terminal 100 could be configured to assume that the server 200 is down, and disconnect from the working server 200.
Should the encoder 212 not shut down cleanly, the host application 210 could be partially running, resulting in loss of control. This could mean that the game 210 could not be restarted and no other game or application could start a video stream as the ports would be locked.

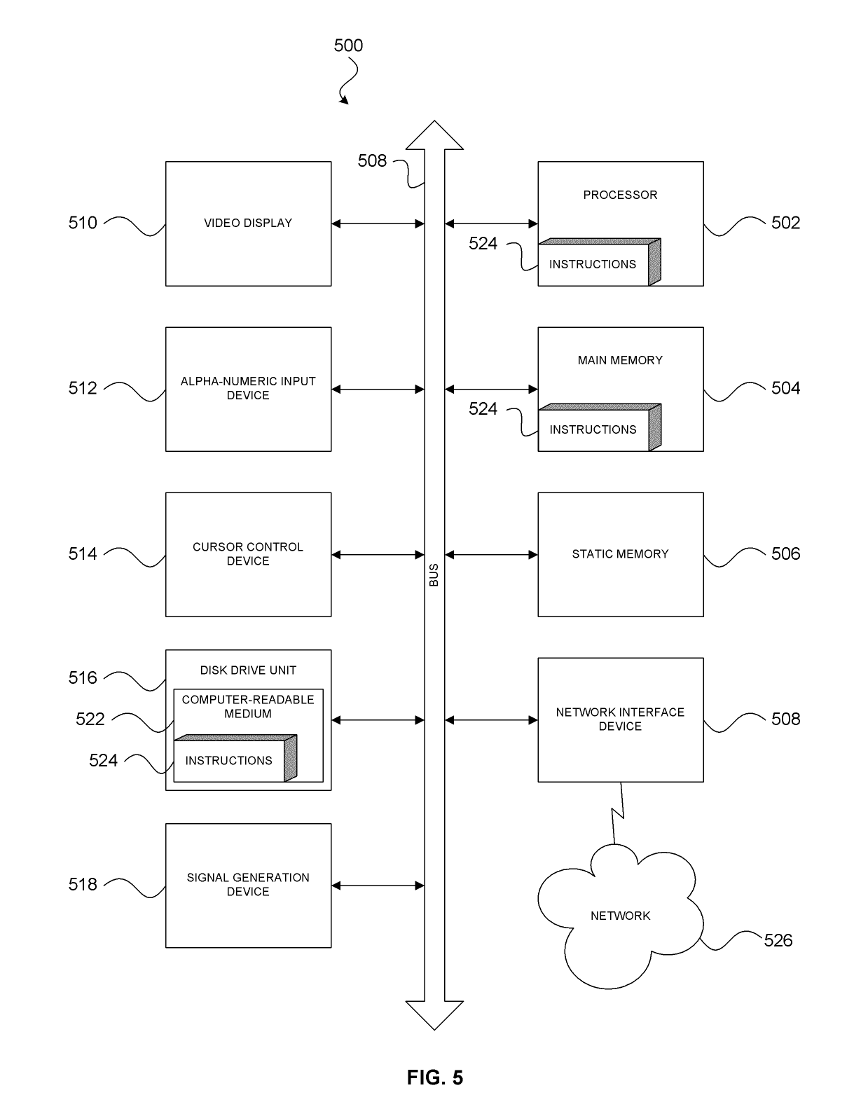

FIG. 5 shows a diagrammatic representation of a computer 500 within which a set of instructions, for causing the computer 500 to perform any one or more of the methodologies computer 500 herein, may be executed. In a networked deployment, the computer 500 may operate in the capacity of a server or a client machine in server-client network environment, or as a peer machine in a peer-to-peer (or distributed) network environment. The computer 500 may be a personal computer (PC), a tablet PC, a set-top box (STB), a Personal Digital Assistant (PDA), a cellular telephone, a web appliance, a network router, switch or bridge, or any computer 500 capable of executing a set of instructions (sequential or otherwise) that specify actions to be taken by that computer 500. Further, while only a single computer 500 is illustrated, the term “computer” shall also be taken to include any collection of computers that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both, a main memory 504 and a static memory 506, which communicate with each other via a bus 508. The computer 500 may further include a video display unit 510 (e.g., a liquid crystal display (LCD)). The computer 500 also includes an alphanumeric input device 512 (e.g., a keyboard), a user interface (UI) navigation device 514 (e.g., a mouse), a disk drive unit 516, a signal generation device 518 (e.g., a speaker) and a network interface device 520.

The disk drive unit 516 includes a computer-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, the main memory 504 and the processor 502 also constituting computer-readable media.

The software 524 may further be transmitted or received over a network 526 via the network interface device 520 utilizing any one of a number of well-known transfer protocols (e.g., HTTP, FTP).

While the computer-readable medium 522 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the computer 500 and that cause the computer 500 to perform any one or more of the methodologies of the present embodiments, or that is capable of storing, encoding or carrying data structures utilized by or associated with such a set of instructions. The term “computer-readable medium” shall accordingly be taken to include, but not be limited to, solid-state memories and optical and magnetic media.

The server 200 may include at least some of the components of the computer 500.

The Applicant believes that the present disclosure is advantageous in that it provides an elegant method of encoding image data in the application which is responsible for creating the image data. This results in low latency (compared to prior encoding methods) which improves streaming services and user experience. The method is applicable to existing applications or games which may not have been intended for operation in a streaming environment. The method also ensures shutdown of the encoder; if the game stops, then the encoder stops. This provides a less complex finite state machine and also implies that each application can be its own streaming server, obviating the need to control or bind applications to servers.

What is claimed is:

1. A method of in-application encoding for decreased latency application streaming in an environment including a three-dimensional image or video generating application and an API, the method including:
providing a customized sub-program in the application, the sub-program including an encoder operable to encode an image;
creating a memory block sufficient to accommodate the largest possible image that the application could generate, the memory block being protected;
copying data from a back buffer of the API to the memory block;
indicating that data in the memory block is ready for encoding; and
encoding, by the sub-program of the application, the data in the memory block for onward streaming of the encoded data.

2. The method as claimed in claim 1, which includes communicating the address of the memory block to the encoder.

3. The method as claimed in claim 1, in which data is copied directly from the back buffer to the memory block for encoding.

4. The method as claimed in claim 1, in which protecting the memory block includes declaring or demarcating the memory block as unsafe.

5. The method as claimed in claim 1, in which:
the application is operable on a Microsoft™ Windows™ platform; and
the sub-program is in the form of a Dynamic Linked Library (DLL).

6. The method as claimed in claim 1, which utilizes a semaphore to regulate protection of the memory block.

7. The method as claimed in claim 6, in which:
the semaphore is a counting semaphore or a binary semaphore;
an increase in the semaphore indicates a memory lock; and
a memory lock indicates that new data is in the memory block and is ready for encoding.

8. The method as claimed in claim 6, in which:
once the data has been encoded, the semaphore is decreased; and
a decrease in the semaphore indicates that the memory block is available to receive new data from the back buffer.

9. The method as claimed in claim 8, in which a decrease in the semaphore triggers copying of the data in the back buffer to the memory block.

10. The method as claimed in claim 1, in which providing the customized sub-program includes patching the application to introduce the sub-program including the encoder.

11. The method as claimed in claim 10, in which the patching includes adding (or replacing) at least one DLL file to an existing DDL system of the application.

12. The method as claimed in claim 10, in which the patching includes changing a memory reference in the application to point to the new sub-program.

13. A system for in-application encoding for decreased latency application streaming in an environment including a three-dimensional image or video generating application and an API, the system including:
an application server operable to stream application images/video to a remote client terminal;
an application operable to render images based on a modeled three-dimensional environment;
an image encoder operable to encode an image; and
a control module operable to:
create a memory block sufficient to accommodate the largest possible image that the application could generate, the memory block being protected;
communicate an address of the memory block to the encoder;
copy data from a back buffer of the API to the memory block; and
indicate that data in the memory block is ready for encoding,
the encoder being operable to encode the data in the memory block for onward streaming of the encoded data.

14. A non-transitory computer-readable medium having stored thereon a computer program which, when executed by a computer, causes the computer to perform the method as claimed in claim 1.
